(19) United States
(12) Patent Application Publication
(10) Pub. No.: US 2023/0384756 A1
(43) Pub. Date: Nov. 30, 2023

(54) TOOL MANAGEMENT DEVICE

(71) Applicant: DMG MORI CO., LTD., Nara (JP)

(72) Inventors: Tetsushi ASADA, NARA (JP); Yoshihiro TAKIGUCHI, NARA (JP); Atsushi HONGO, Hokkaido (JP)

(73) Assignee: DMG MORI CO., LTD., Nara (JP)

(21) Appl. No.: 18/142,874

(22) Filed: May 3, 2023

(30) Foreign Application Priority Data
May 24, 2022 (JP) 2022-084269

(51) Int. Cl. G05B 19/406

(52) U.S. Cl. CPC G05B 19/406; G05B 2219/36359

(57) ABSTRACT

A tool management device includes a data storage unit for storing (i) tool information including a location of a tool and (ii) a tool-bench information including at least a correspondence between a machine tool and a tool bench, a tool management unit for changing data in the tool information, and a reception unit for receiving a detachment notification when a tool is detached from the machine tool. If the detachment notification is received, the tool management unit changes the location of the tool in the tool information from (a) the machine tool to (b) the tool bench corresponding to the machine tool in the tool-bench information.

### BACKGROUND OF INVENTION

### 1. Field

The present invention relates to a technology for managing tools used in machine tools.

### 2. Description of Related Art

Machine tools include devices for cutting a workpiece into a desired shape, and devices for depositing metal powder or the like to make a workpiece. Examples of machine tools for cutting include a turning center that machines a workpiece by applying a cutting tool to the workpiece that is being turned, a machining center that machines a workpiece by applying a turning tool to the workpiece, and a combined machine including these functions in combination.

A tool is fixed to a tool holding portion such as a spindle or a turret. A machine tool machines a workpiece while changing the tool and moving the tool holding portion in accordance with a machining program provided in advance. The cutting edge of the tool is gradually worn due to friction with the workpiece. A worker detaches the tool from the machine tool and inspects the tool in a tool-change area, as appropriate. When the tool is so worn that it is not suitable for further use, it is necessary to replace the detached tool with a new tool.

### RELATED ART LIST

Patent Literature 1: JP 6851525 B

In general, after detaching the tool from the machine tool, the worker temporarily places this tool on a cart near the machine tool. The worker then pushes the cart to carry the tool to the tool-change area. The work of carrying the tool using the cart between a machining area where the machine tool is installed and the tool-change area for tool inspection and change is prone to cause reduction of work efficiency.

### SUMMARY OF INVENTION

A tool management device according to an aspect of the present invention includes: a data storage unit for storing (i) tool information including a location of a tool and (ii) a tool-bench information including at least a correspondence between a machine tool and a tool bench; a tool management unit for updating data included in the tool information; and a reception unit for receiving a detachment notification when a tool is detached from the machine tool.

If the detachment notification is received, the tool management unit changes the location of the tool in the tool information from (a) the machine tool to (b) the tool bench corresponding to the machine tool in the tool-bench information.

According to the present invention, a tool detached from a machine tool can also be managed appropriately.

### BRIEF DESCRIPTION OF DRAWINGS

FIG. 1 is a schematic diagram for explaining a relation between a machining area, a tool-change area, and an automatic transfer machine;

FIG. 2 illustrates a hardware configuration of a tool management system and functional blocks of a tool management device;

FIG. 3 is a functional block diagram of the automatic transfer machine;

FIG. 4 is a data structure diagram of tool-bench installation information;

FIG. 5 is a data structure diagram of tool information;

FIG. 6 illustrates a data structure of machine storing information and the appearance of a machine tool;

FIG. 7 illustrates a data structure of tool-bench storing information and the appearance of a tool bench;

FIG. 8 illustrates a data structure of transfer-machine storing information and the appearance of an automatic transfer machine;

FIG. 9 illustrates a transfer instruction screen;

FIG. 10 illustrates an attachment screen;

FIG. 11 is a sequence diagram of a processing procedure when a tool is detached from the machine tool and carried into the tool bench near the machine tool;

FIG. 12 is a sequence diagram of a processing procedure when the automatic transfer machine is caused to transfer a tool in the tool bench;

FIG. 13 is a data structure diagram of transfer instruction information;

FIG. 14 is a sequence diagram of a processing procedure when the automatic transfer machine carries a tool into the tool bench in the tool-change area;

FIG. 15 is a sequence diagram of a processing procedure when the automatic transfer machine transfers a tool to the machining area; and

FIG. 16 is a sequence diagram of a processing procedure of carrying a tool into the tool bench in the machining area and then attaching the tool to the machine tool.

### DETAILED DESCRIPTION

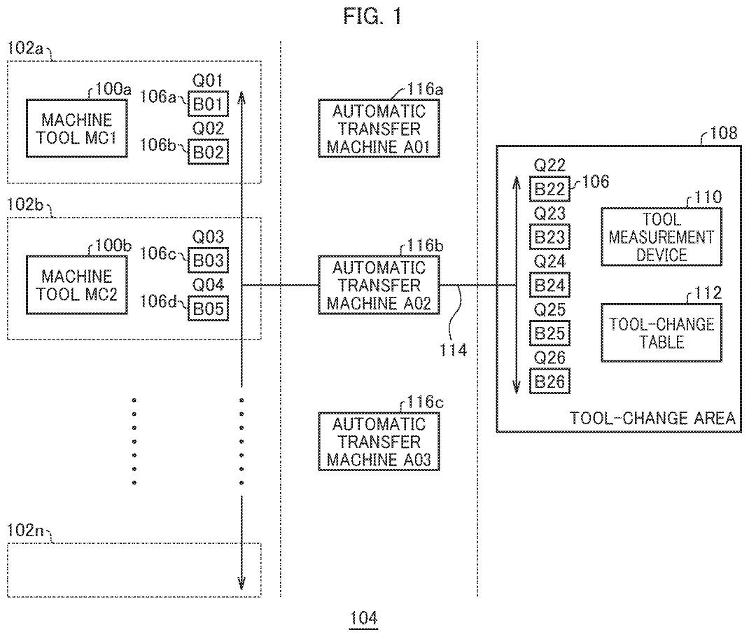

FIG. 1 is a schematic diagram for explaining a relation between a machining area 102, a tool-change area 108, and an automatic transfer machine 116.

A plurality of machining areas 102 (machining areas 102a, 102b, . . . , 102n) are provided in a factory 104 illustrated in FIG. 1. Each machining area 102 is an area including a machine tool 100 and a plurality of tool benches 106. In the present embodiment, two tool benches 106 are associated with one machine tool 100.

The machine tool 100 is assumed to be a machining center, a turning center, or a combined machine. The machine tool 100 includes a tool storage unit that is generally called a magazine. The tool storage unit stores a plurality of tools. Pots of the tool storage unit, in which the tools are respectively stored, are identified by “pot numbers”.

As described above, the machining areas 102 are set in the factory 104, and the machine tool 100 is installed in each machining area 102. The machine tool 100 is identified by a “machine ID”. For example, the machine ID of a machine tool 100a installed in the machining area 102a is “MC1”. In the following descriptions, the machine tool 100a with a machine ID of MC1 is represented as the “machine tool 100(MC1)”. Similarly, the machine ID of a machine tool 100b in the machining area 102b is “MC2”, and therefore the machine tool 100b is represented as the “machine tool 100(MC2)”.

The tool bench 106 is installed near the machine tool 100. The tool bench 106 is identified by a “tool-bench ID”. For example, the tool-bench ID of a tool bench 106a in the machining area 102a is “B01”, and the tool-bench ID of a tool bench 106b is “B02”. In the following descriptions, the tool bench 106a with a tool-bench ID of B01 is represented as the “tool bench 106(B01)”.

Although the tool bench 106 in the present embodiment is configured as a cart, the configuration is not limited thereto. The tool bench may be a table fixed at a position at which a tool detached from the machine tool 100 by an arm robot can be placed as it is. Further, even in a case where the tool bench 106 is configured as a cart, one of two carts may be set to be fixed so as not to be movable, and the other may be set to be movable by a worker. The worker can temporarily place a plurality of tools on the tool bench 106. Pots of the tool bench 106, in which the tools are stored, respectively, are also identified by “pot numbers”. More specifically, a tool having a predetermined weight or more, for example, 10 kg or more may be placed on the movable one of the tool benches 106 and be carried by human power, i.e., by the worker.

The tool bench 106 in the present embodiment is installed and fixed in the factory 104, and the location thereof is identified by a “location number”. When the tool bench 106 is newly installed in the factory 104, the worker registers the tool-bench ID, the location number, and the location coordinate of the tool bench 106 in the factory 104 in a tool management device 200 described later. Therefore, when knowing the tool-bench ID of the tool bench 106, the worker can know the location of that tool bench 106. For example, the location number of the tool bench 106(B01) is “Q01”, and the location number of a tool bench 106(B02) is “Q02”. The location coordinate of the tool bench 106(B01) is made to correspond to the location number “Q01”, and the location coordinate of the tool bench 106(B02) is made to correspond to the location number “Q02”.

The location coordinate may be managed by a transfer control device 124 described later, not by the tool management device 200. That is, the tool-bench ID, the location number, and the location coordinate may be made to correspond to one another in the transfer control device 124. In addition, the tool management device 200 and the transfer control device 124 may be configured in such a manner that each of them can refer to such information on the location in the other device or they can exchange such information with each other.

The tool-change area 108 is a place for tool inspection and tool change. The machining area 102 and the tool-change area 108 are normally apart from each other by several meters to tens meters. In the tool-change area 108, a tool measurement device 110, a tool-change table 112, and the tool benches 106 are installed. The tool measurement device 110 is a device for inspecting tool wear and breakage. The tool-change table 112 is a table for performing tool change thereon by detaching a tool from a holder and a shank and attaching a new tool (cutting edge) to the shank. Tool benches 106(B22) to 106 (B26) installed in the tool-change area 108 are also identified by tool-bench IDs, and have location numbers set therefor, respectively.

In the factory 104, a plurality of the automatic transfer machines 116 (automatic transfer machines 116a to 116c) are further installed. The automatic transfer machine 116 is a self-propelled robot that has a robot arm and can carry a tool.

The automatic transfer machine 116 sets a moving route 114 connecting the tool bench 106 in the machining area 102 and the tool bench 106 in the tool-change area 108 to each other. More specifically, the arrangement of objects in the factory 104 is detected by a locator (not illustrated) installed in the factory 104. The automatic transfer device 116 moves in the factory 104 based on the object arrangement to create map information in advance. The automatic transfer machine 116 determines its moving direction based on its current position while referring to the map information, whereby the actual moving routes 114 is determined. In addition, the automatic transfer machine 116 stops automatically when detecting an obstacle, such as a worker, with a sensor, thereby avoiding collision with the obstacle.

The automatic transfer machine 116 in the present embodiment carries a tool between the tool bench 106 in the machining area 102 and the tool bench 106 in the tool-change area 108.

The automatic transfer machine 116 is identified by a “transfer machine ID”. For example, the transfer machine ID of the automatic transfer machine 116a is “A01”, and the transfer machine ID of an automatic transfer machine 116b is “A02”. In the following descriptions, the automatic transfer machine 116a with a transfer machine ID of A01 is represented as the “automatic transfer machine 116(A01)”. The automatic transfer machine 116 also has a plurality of pots for storing tools therein, and the pots are identified by pot numbers. The moving route 114 illustrated in FIG. 1 represents a moving route assumed for the automatic transfer machine 116(A02).

In the following descriptions, a worker mainly in charge of machining a workpiece in the machining area 102 is referred to as a “machining worker”, and a worker who performs tool inspection and tool change in the tool-change area 108 is referred to as a “changing worker”. When those workers are not specifically distinguished from each other, they are simply referred as “workers”.

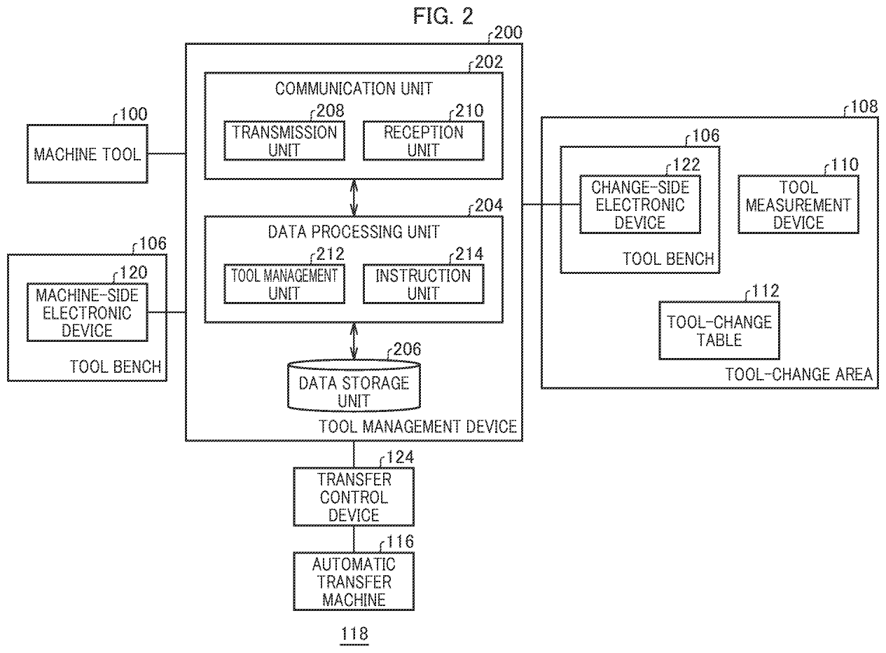

FIG. 2 illustrates a hardware configuration of a tool management system 118 and functional blocks of the tool management device 200.

The tool management device 200 is a device for managing the location of a tool. The machine tool 100 is connected to the tool management device 200. The machine tool 100 transmits a detachment notification to the tool management device 200 when a tool in its tool storage unit is detached. Further, when a new tool is attached to a tool holding portion or the like by a machining worker, the machine tool 100 transmits an attachment notification to the tool management device 200. The attachment notification and the detachment notification each include a machine ID, a tool ID for identifying a tool, and a pot number of a pot for which attachment or detachment of the tool is performed.

A machine-side electronic device 120 is installed near the tool bench 106 in the machining area 102. In the machining area 102, the tool bench 106 and the machine-side electronic device 120 are made to correspond to each other in one-to-one correspondence. As the examples of the machine-side electronic device 120, a personal computer (PC), an electronic tablet, and a smartphone are assumed. The machining worker operates the machine-side electronic device 120, thereby being able to instruct tool transfer by the automatic transfer machine 116 (described later). In addition, the machining worker can check the state of storing tools by accessing the tool management device 200 by means of the machine-side electronic device 120.

One machine-side electronic device 120 may be made to correspond to a plurality of the tool benches 106. In this case, one of the tool benches 106 which is a transfer source may be selected in the machine-side electronic device 120.

A change-side electronic device 122 is installed near the tool bench 106 in the tool-change area 108. In the tool-change area 108, the tool bench 106 and the change-side electronic device 122 are made to correspond to each other in one-to-one correspondence. The change-side electronic device 122 is also a computer terminal such as a personal computer. A changing worker operates the change-side electronic device 122, thereby being able to instruct tool transfer. In addition, the changing worker can check the state of storing tools by means of the change-side electronic device 122.

Also in the tool-change area 108, one change-side electronic device 122 may be made to correspond to a plurality of, for example, five tool benches 106.

The transfer control device 124 manages the automatic transfer machines 116. The automatic transfer machines 116 each operate in accordance with an instruction from the transfer control device 124.

Next, the functional block diagram of the tool management device 200 is described.

The components of the tool management device 200 are implemented by hardware including computing units such as central processing units (CPUs) and various co-processors, storage devices such as memories and storages, and wired or wireless communication lines that connect these units and devices, and software that is stored in the storage devices and supplies processing instructions to the computing units. Computer programs may be constituted by device drivers, operating systems, various application programs on upper layers thereof, and a library that provides common functions to these programs. Blocks that are described below do not refer to configurations in units of hardware but to blocks in units of functions.

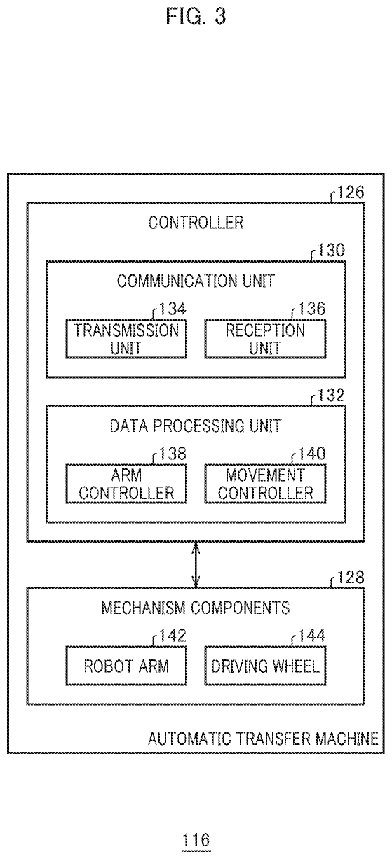

The same holds true for the functional blocks of the automatic transfer machine 116 described later with reference to FIG. 3.

The tool management device 200 includes a communication unit 202, a data processing unit 204, and a data storage unit 206.

The communication unit 202 performs processing of communication with an external device such as the machine tool 100, the machine-side electronic device 120, the change-side electronic device 122, and the transfer control device 124. The data processing unit 204 performs various types of processing based on data acquired by the communication unit 202 and data stored in the data storage unit 206. The data processing unit 204 also functions as an interface of the communication unit 202 and the data storage unit 206. The data storage unit 206 stores various programs and setting data therein.

The communication unit 202 includes a transmission unit 208 that transmits data and a reception unit 210 that receives data.

The data processing unit 204 includes a tool management unit 212 and an instruction unit 214. The tool management unit 212 manages the location of a tool. The instruction unit 214 generates various instructions for the transfer control device 124 which are to be issued to the automatic transfer machine 116. Furthermore, the instruction unit 214 instructs a position where a tool is to be attached (a position of a pot in the tool bench 106) to a worker via, for example, the machine-side electronic device 120 or the change-side electronic device 122.

FIG. 3 is a functional block diagram of the automatic transfer machine 116.

The automatic transfer machine 116 includes mechanism components 128 as a hardware mechanism and a controller 126 that is implemented by an electronic device and a computer program and controls the mechanism components 128. The mechanism components 128 include a robot arm 142 for gripping a tool and driving wheels 144.

The controller 126 includes a communication unit 130 performing communication with the transfer control device 124 and a data processing unit 132 controlling the mechanism components 128 in accordance with an instruction from the communication unit 130.

The communication unit 130 includes a transmission unit 134 that transmits data and a reception unit 136 that receives data. The data processing unit 132 includes an arm controller 138 controlling the robot arm 142 and a movement controller 140 controlling the driving wheels 144.

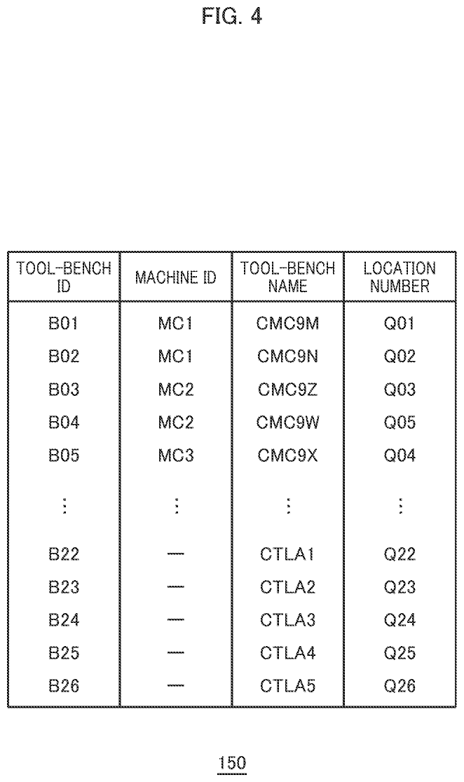

FIG. 4 is a data structure diagram of tool-bench installation information 150.

The tool-bench installation information 150 is stored in the data storage unit 206 in the tool management device 200. When the tool bench 106 is installed in the factory 104, a worker registers the tool bench 106 in the tool-bench installation information 150. As described above, the tool bench 106 is identified by a tool-bench ID and is made to correspond to the machine tool 100 or the tool-change area 108.

According to FIG. 4, the tool bench 106(B01) is made to correspond to the machine tool 100(MC1). The name of the tool bench 106(B01) is “CMC9M”. Further, the location number of the tool bench 106(B01) is “Q01”. As described above, the location coordinate (not illustrated) in the factory 104 is made to correspond to the location number “Q01” in advance.

The tool bench 106(B01) and the tool bench 106(B02) are made to correspond to the machine tool 100(MC1). A tool bench 106(B03) and a tool bench 106(B04) are made to correspond to the machine tool 100(MC2) (see FIG. 1). Meanwhile, the tool benches 106(B22) and the like are not made to correspond to any machine tool 100. These tool benches 106(B22) to 106(B26) are not installed in the machining area 102, but are installed in the tool-change area 108 (see FIG. 1).

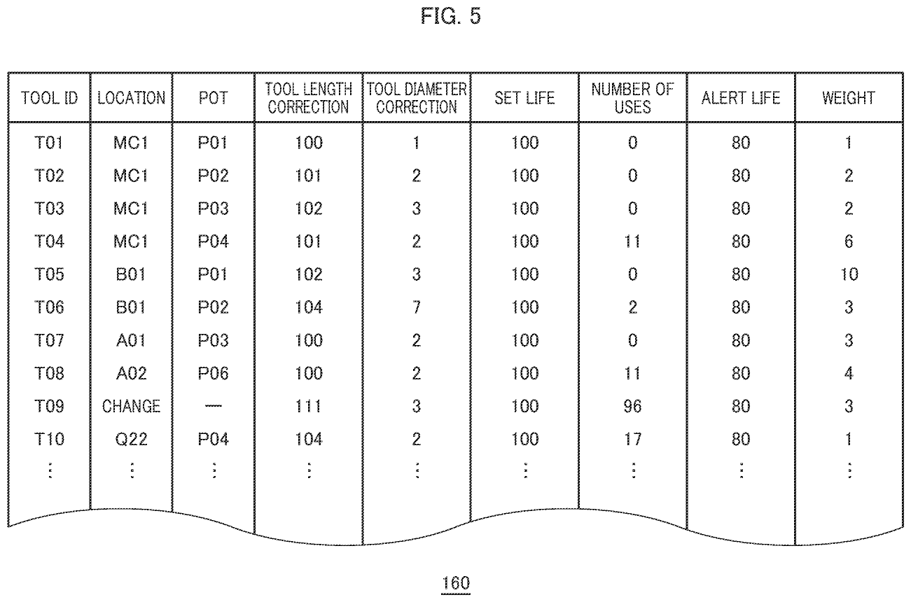

FIG. 5 is a data structure diagram of tool information 160.

The tool information 160 is stored in the data storage unit 206 in the tool management device 200. The tool information 160 is data for managing the location of a tool. According to FIG. 5, a tool with a tool ID of 101 (hereinafter, “tool (T01)”) is stored in a pot with a pot number of P01 in the tool storage unit of the machine tool 100(MC1). Further, a tool (T09) is illustrated as being changed currently. A “tool length correction” field indicates a correction value in the longitudinal direction of a tool, and a “tool diameter correction” field indicates a correction value in the radial direction of a tool.

A “set life” field in the tool information 160 indicates a set life. When the number of uses of a tool reaches the set life (the number of times), the tool management unit 212 notifies the machine tool 100 that tool inspection is to be performed. The machine tool 100 instructs, on an operation screen (not illustrated) of its own device, a machining worker to perform tool inspection. A “number of uses” field indicates the number of uses of a tool. Every time the machine tool 100 indexes a tool to the tool holding portion, the machine tool 100 notifies the tool management device 200 of a tool ID, and the tool management unit 212 updates the number of uses of that tool.

An “alert life” field in the tool information 160 indicates the number of uses at which an alert notification is to be sent to a worker to promote tool inspection soon. For example, when the number of uses of the tool (T01), which is currently “0”, reaches the number of uses “80” at which an alert has to be issued, the machine tool 100 recommends a machining worker to inspect the tool (T01).

The weight of a tool is classified into weight ranks 1 to 10 in advance. A “weight” field in the tool information 160 indicates the weight rank of a tool. A tool having a higher weight rank is heavier. The tool management unit 212 updates the tool information 160 as appropriate when a tool is newly registered and when a tool is moved. In the present embodiment, the rank is set to increase every time the tool weight increases by 0.1 kg.

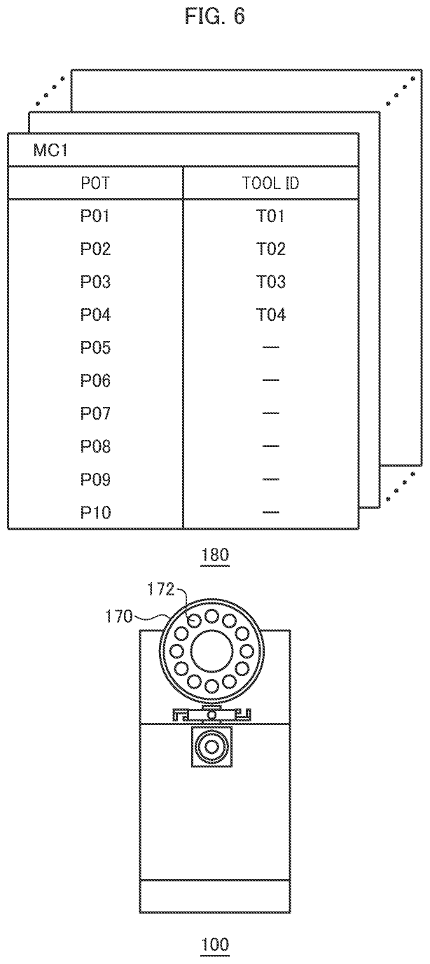

FIG. 6 illustrates a data structure of machine storing information 180 and the appearance of the machine tool 100.

The machine tool 100 includes a tool storage unit 170 having a plurality of pots 172.

The machine storing information 180 is stored in the data storage unit 206 in the tool management device 200. The machine storing information 180 indicates the state of storing tools in the machine tool 100. FIG. 6 illustrates the machine storing information 180 of the machine tool 100(MC1).

In a pot 172 with a pot number of P01 (hereinafter, “pot 172(P01)”) of the machine tool 100(MC1), the tool (T01) is stored (see FIG. 5). Tools (T02), (T03), and (T04) are respectively stored in other pots 172(P02), 172(P03), and 172(P04). Pots 172(P05) to 172(P10) of the machine tool 100(MC1) are empty.

When a machining worker detaches a tool from the tool storage unit 170 of the machine tool 100, the machine tool 100 transmits a detachment notification to the tool management device 200, and the tool management unit 212 of the tool management device 200 updates the machine storing information 180. When a tool is attached to an empty pot of the tool storage unit 170, the machine tool 100 transmits an attachment notification to the tool management device 200, and the tool management unit 212 updates the machine storing information 180. The tool management unit 212 also updates the tool information 160 in response to attachment/detachment of a tool.

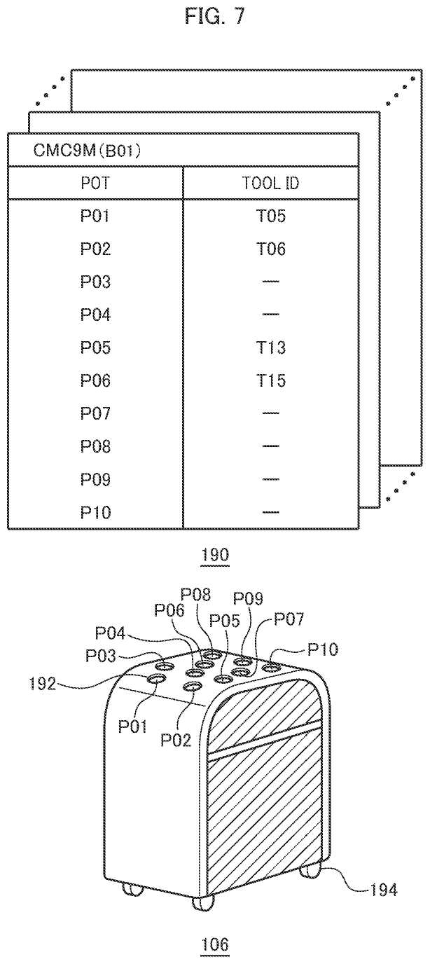

FIG. 7 illustrates a data structure of tool-bench storing information 190 and the appearance of the tool bench 106.

The tool bench 106 includes casters 194 and is configured to be movable. In the present embodiment, since the casters 194 are fixed, the tool bench 106 cannot be moved after being installed. A plurality of pots 192 are formed in the ceiling of the tool bench 106. A worker can store a tool with a holder and a shank attached thereto in the pot 192. The tool bench 106 is not provided with any electrical mechanism. As described above, the machine-side electronic device 120 or the change-side electronic device 122 is made to correspond to the tool bench 106.

The tool-bench storing information 190 is stored in the data storage unit 206 of the tool management device 200. The tool-bench storing information 190 indicates the state of storing tools in the tool bench 106. FIG. 7 illustrates the tool-bench storing information 190 of the tool bench 106(B01). The tool-bench name of the tool bench 106(B01) is “CMC9M” (see FIG. 4).

In a pot 192(P01) of the tool bench 106(B01), a tool (T05) is stored (see FIG. 5). Meanwhile, a pot 192(P03) of the tool bench 106(B01) is empty.

When a worker attaches a tool to the tool bench 106(B01), the tool management unit 212 refers to the tool-bench storing information 190, and the instruction unit 214 instructs the worker of an empty pot to which that tool is to be attached. After issuing the attachment instruction, the tool management unit 212 updates the tool-bench storing information 190 (described later). The tool management device 200 also updates the tool-bench storing information 190 when the automatic transfer machine 116 or the like picks up a tool from the tool bench 106(B01).

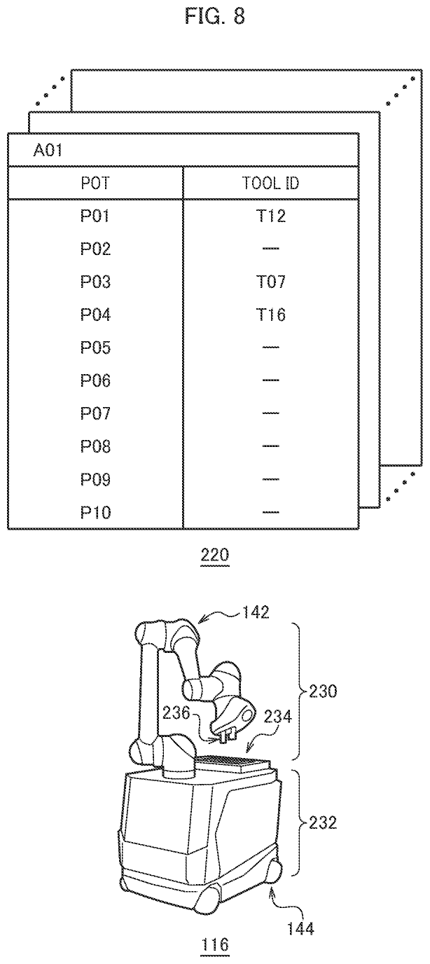

FIG. 8 illustrates a data structure of transfer-machine storing information 220 and the appearance of the automatic transfer machine 116.

The automatic transfer machine 116 includes a working portion 230 and a self-propelled portion 232. The working portion 230 and the self-propelled portion 232 correspond to the mechanism components 128 described with reference to FIG. 3. The controller 126 of the automatic transfer machine 116 is configured by an electronic circuit and a computer program for controlling the working portion 230 and the self-propelled portion 232.

The self-propelled portion 232 includes the driving wheels 144. The self-propelled portion 232 has a sensor (not illustrated) mounted thereon. The movement controller 140 controls the driving wheels 144 to move the automatic transfer machine 116.

A tool storage unit 234 is provided in the working portion 230. The tool storage unit 234 also has a plurality of pots for storing tools therein. A hand 236 for gripping a tool is formed at the distal end of the robot arm 142 formed in the working portion 230. The robot arm 142 picks up a tool from the tool bench 106 and stores the tool thus picked up in an empty pot of the tool storage unit 234 located behind the robot arm 142. The robot arm 142 can also pick up a tool from the tool storage unit 234 and store the tool in an empty pot of the tool bench 106.

The transfer-machine storing information 220 is stored in the data storage unit 206 of the tool management device 200. The transfer-machine storing information 220 indicates the state of storing tools in the automatic transfer machine 116. FIG. 8 illustrates the transfer-machine storing information 220 of the automatic transfer machine 116(A01).

In a pot (P01) of the automatic transfer machine 116(A01), a tool (T12) is stored. A pot (P02) of the automatic transfer machine 116(A01) is empty. In a pot (P03) of the automatic transfer machine 116(A01), a tool (T07) is stored (see FIG. 5).

When the robot arm 142 stores a tool in the tool storage unit 234 of the automatic transfer machine 116(A01), the tool management unit 212 updates the transfer-machine storing information 220 (described later). The tool management unit 212 also updates the transfer-machine storing information 220 when the automatic transfer machine 116 stores a tool in the tool bench 106(B01).

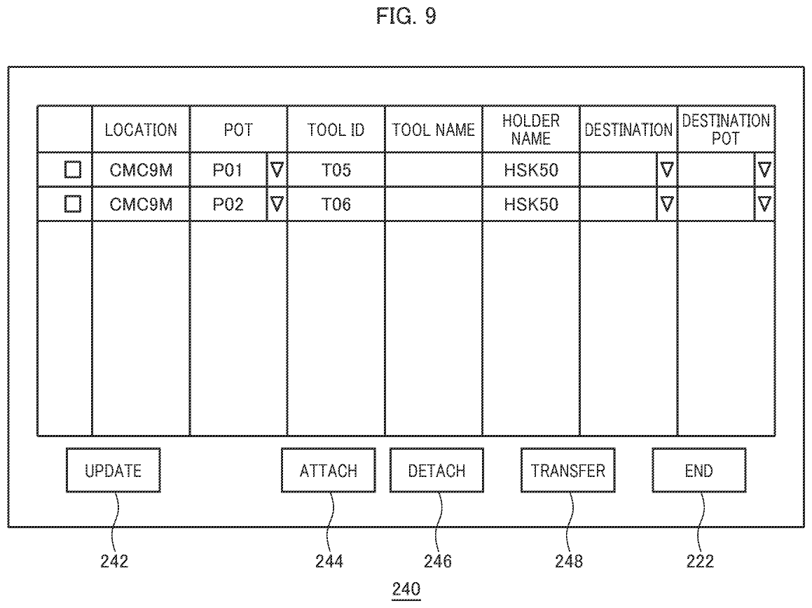

FIG. 9 illustrates a transfer instruction screen 240.

The transfer instruction screen 240 is displayed on the machine-side electronic device 120 or the change-side electronic device 122. Here, description is made assuming the transfer instruction screen 240 displayed on the machine-side electronic device 120 corresponding to the tool bench 106(B01) in the machining area 102.

The tool management device 200 configures the transfer instruction screen 240 based on various types of data including, for example, the tool-bench installation information 150 (see FIG. 4), the tool information 160 (see FIG. 5), the machine storing information 180 (see FIG. 6), the tool-bench storing information 190 (see FIG. 7), and the transfer-machine storing information 220 (see FIG. 8), and causes the machine-side electronic device 120 to display the transfer instruction screen 240.

When a worker touches an update button 242, the machine-side electronic device 120 transmits an update request to the tool management device 200, acquires latest data from the tool management device 200, and updates the transfer instruction screen 240. According to the transfer instruction screen 240 in FIG. 9, the tool (T05) is stored in the pot 192(P01) of the tool bench 106(B01: CMC9M), and the holder name of the tool (T05) is “HSK50”. Further, a tool (T06) is stored in a pot 192(P02) (see FIGS. 5 and 7).

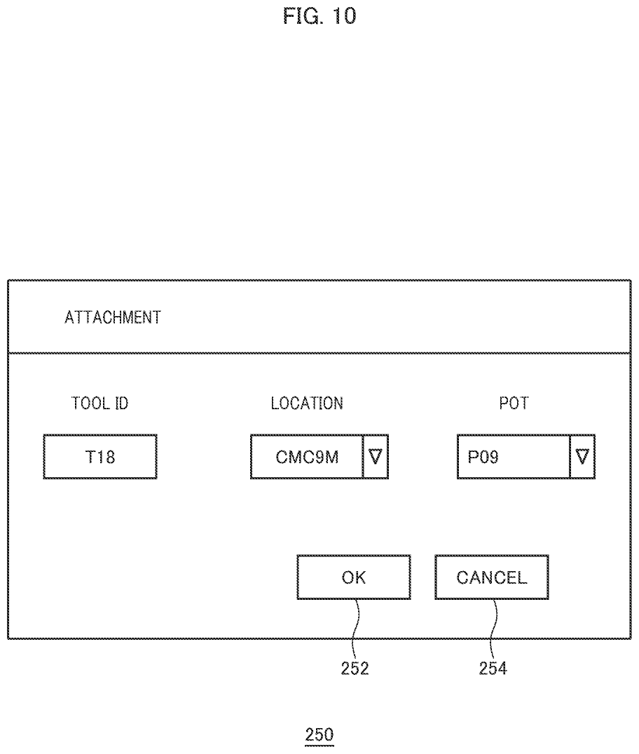

When attaching a tool to the tool bench 106(B01), the worker touches an attachment button 244. When the worker touches the attachment button 244, an attachment screen 250 (see FIG. 10) is displayed. Manual tool attachment to the tool bench 106 will be described later. Hereinafter, attaching a tool to the tool bench 106 or the like is referred to as “carrying-in”.

When detaching a tool from the tool bench 106(B01), the worker touches a detachment button 246. When the worker touches the detachment button 246, a detachment screen (not illustrated) is displayed, and the worker specifies a pot in which the tool to be detached from the tool bench 106 is stored. Hereinafter, detaching a tool from the tool bench 106 or the like is referred to as “carrying-out”.

When the worker transfers a tool stored in the tool bench 106 to the other tool bench 106, the worker touches a transfer button 248. For example, when the worker transfers the tool (T05) stored in the pot 192(P01) of the tool bench 106(B01) to a pot 192(P05) of the tool bench 106(B22) in the tool-change area 108, the worker selects, with regard to a row corresponding to the tool (T05), “B22” in a “transfer destination” field and “P05” in a “transfer destination pot” field and then touches the transfer button 248. Input to the “transfer destination pot” field is optional. The tool management unit 212 may select one of empty pots of the tool 106(B22), which is a transfer destination, as described later.

When the transfer button 248 is touched, a transfer request is transmitted from the machine-side electronic device 120 to the tool management device 200. The transfer request includes a tool-bench ID and a pot number of a transfer source, a tool ID of a tool to be transferred, and a tool-bench ID and a pot number of a transfer destination. The tool management device 200 instructs the automatic transfer machine 116 to transfer the tool (T05) via the transfer control device 124. Here, it is assumed that the automatic transfer machine 116(A01) is selected.

Upon receiving the transfer instruction, the automatic transfer machine 116(A01) carries out the tool (T05) from the tool bench 106(B01) and stores it in the tool storage unit 234 of its own device. The automatic transfer machine 116(A01) then moves to near the tool bench 106(B22) as a transfer destination and carries the tool (T05) into the pot 192(P05) of the tool bench 106(B22).

As for the transfer instruction screen 240 displayed on the change-side electronic device 122, the operation method is the same.

FIG. 10 illustrates the attachment screen 250.

As described above, when a worker stores a tool in an empty one of the pots 192 of the tool bench 106(B01), the worker causes the attachment screen 250 to be displayed. FIG. 10 illustrates an input state when the worker carries a tool (T18) into a pot 192(P09) of the tool bench 106(CMC9M: B01). The worker brings the tool (T18) therewith, carries the tool (T18) into the empty pot 192(P09) of the tool bench 106(B01), and then touches an OK button 252. At this time, an attachment notification is transmitted from the machine-side electronic device 120 to the tool management device 200. The attachment notification includes a tool-bench ID, a tool ID, and a pot number. The instruction unit 214 of the tool management device 200 updates various types of data such as the tool-bench storing information 190 in accordance with the attachment notification.

When a cancel button 254 is touched, no attachment notification is transmitted.

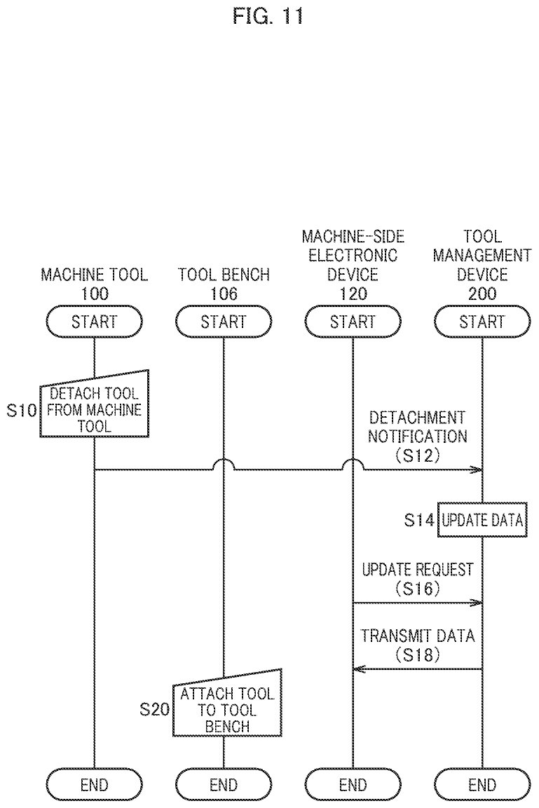

FIG. 11 is a sequence diagram of a processing procedure when a tool is detached from the machine tool 100 and carried into the tool bench 106 near the machine tool 100.

First, a machining worker detaches a tool as a target of inspection and/or change from the machine tool 100 (S10). The machining worker may detach the tool from the tool holding portion of the machine tool 100 or from the tool storage unit 170. Upon detecting detachment of the tool, the machine tool 100 transmits a detachment notification to the tool management device 200 (S12). The reception unit 210 of the tool management device 200 receives the detachment notification.

Here, description is made assuming a case where the tool (T01) is detached from the pot 172 (P01) of the machine tool 100(MC1) (see FIG. 6).

The tool management unit 212 updates data such as the machine storing information 180 in accordance with the detachment notification (S14). Specifically, as for the machine storing information 180 of the machine tool 100(MC1), the tool management unit 212 changes the pot 172(P01) in which the tool (T01) has been stored to an empty pot. The tool management unit 212 then refers to the tool-bench installation information 150, identifies the tool benches 106(B01) and 106(B02) corresponding to the machine tool 100(MC1), and searches for an empty pot in these two tool benches 106 based on the tool-bench storing information 190. It is assumed here that the tool management unit 212 selects the pot 192(P03) of the tool bench 106(B01). The tool management unit 212 updates the tool-bench storing information 190, and sets the tool (T01) for the pot 192(P03) of the tool bench 106(B01) in advance.

The worker who has detached the tool (T01) touches the update button 242 on the transfer instruction screen 240 of the machine-side electronic device 120. At this time, the machine-side electronic device 120 transmits an update request to the tool management device 200 (S16). The instruction unit 214 instructs the machine-side electronic device 120 to store the tool (T01) in the pot 192(P03) of the tool bench 106(B01). At this time, the transmission unit 208 transmits an instruction including the tool-bench ID (B01) and the pot number (P03) (S18).

The worker attaches the tool (T01) to the pot 192(P03) of the tool bench 106(B01) in accordance with the instruction (S20).

As described above, when detaching the tool (T01) from the machine tool 100(MC1), the machining worker is notified of the tool bench 106 and an empty pot into which the tool (T01) is carried in the machine-side electronic device 120 near the machine tool 100(MC1). The machining worker carries the tool (T01) into the specified storage location. In this processing procedure, the tool management device 200 updates various types of data such as the tool information 160, the machine storing information 180, and the tool-bench storing information 190, and tracks and manages the location of the tool (T01).

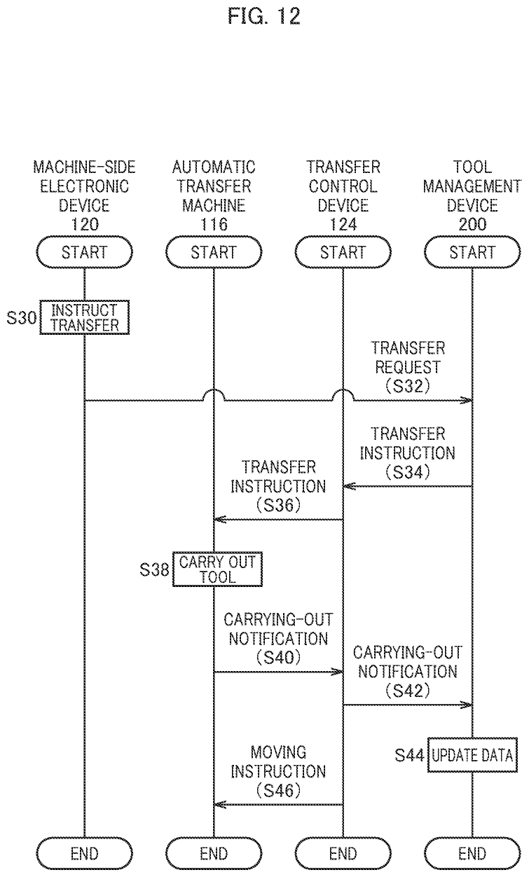

FIG. 12 is a sequence diagram of a processing procedure when the automatic transfer machine 116 is caused to transfer a tool in the tool bench 106.

Next, description is made assuming a case where the tool (T01) stored in the tool bench 106(B01) is transferred to the other tool bench 106(B22). First, on the machine-side electronic device 120 corresponding to the tool bench 106(B01), the machining worker specifies the tool bench 106(B22) as a transfer destination and touches the transfer button 248 (S30). At this time, the machine-side electronic device 120 transmits a transfer request including the tool-bench ID (B01) of the tool bench 106 and the pot number (P03) as a transfer source, the tool (T01) as a transfer target, and the tool-bench ID (B22) of the tool bench 106 as the transfer destination to the tool management device 200 (S32).

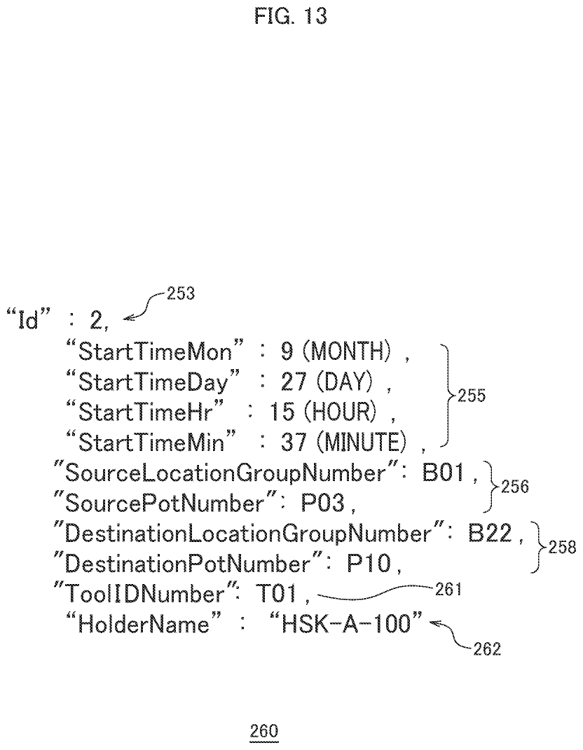

The tool management device 200 receives the transfer request from the machine-side electronic device 120 and transmits a transfer instruction to the transfer control device 124 (S34). Details of the transfer instruction transmitted from the tool management device 200 to the transfer control device 124 will be described with reference to the next drawing, i.e., FIG. 13. At this time, the tool management unit 212 selects the pot 192 as the carrying-in destination of the tool (T01) from empty pots of the tool bench 106(B22) as the transfer destination. It is assumed here that a pot 192 (P10) of the tool bench 106(B22) is selected.

The transfer control device 124 selects the automatic transfer machine 116 that is to transfer the tool (T01). The automatic transfer machine 116 may be selected in any method. The transfer control device 124 may preferentially select the automatic transfer machine 116 that is not moving. The following description is made assuming that the transfer control device 124 selects the automatic transfer machine 116(A01).

The transfer control device 124 instructs the automatic transfer machine 116(A01) to transfer the tool (T01) (S36). This transfer instruction includes, for example, the tool (T01), the tool-bench ID of the tool bench 106(B01) and the pot number as a source of carrying-out and the tool-bench ID of the tool bench 106(B22) and the pot number as a destination of carrying-out.

The automatic transfer machine 116(A01) receives the transfer instruction from the transfer control device 124. The automatic transfer machine 116(A01) moves toward the tool bench 106(B01) and carries out the tool (T01) from the pot 192(P03) of the tool bench 106(B01) with the robot arm 142 (S38).

The automatic transfer machine 116(A01) carries out the tool (T01) and stores it in the tool storage unit 234 of its own device, and then transmits a carrying-out notification to the transfer control device 124 (S40). The carrying-out notification includes the transfer machine ID (A01) and a pot number of a pot into which the tool (T01) has been carried in the tool storage unit 234. Here, it is assumed that the automatic transfer machine 116(A01) has stored the tool (T01) in a pot (P04) of the tool storage unit 234. The transfer control device 124 transmits the carrying-out notification further to the tool management device 200 (S42). Upon receiving the carrying-out notification, the tool management unit 212 updates data of the tool information 160, the tool-bench storing information 190, and the transfer-machine storing information 220 in such a manner that the location of the tool (T01) is changed from the tool bench 106(B01: P03) to the automatic transfer machine 116(A01: P04) (S44).

Subsequently, the transfer control device 124 transmits a moving instruction including the location number or the location coordinate of the tool bench 106(B22) as the transfer destination of the tool (T01) to the automatic transfer machine 116(A01) (S46). Based on this moving instruction, the automatic transfer machine 116(A01) carries the tool (T01) toward the tool bench 106(B22).

FIG. 13 is a data structure diagram of transfer instruction information 260.

The transfer instruction information 260 is transmitted from the tool management device 200 to the transfer control device 124 (see S34 in FIG. 12). A command ID for identifying the transfer instruction information 260 is described in a command ID field 253. A date-and-time field 255 indicates transmission date and time of the transfer instruction information 260. The transfer instruction information 260 illustrated in FIG. 13 has been transmitted at 15:37 on September 27.

A transfer-source field 256 indicates the tool bench 106 and its pot number of a transfer source, and a transfer-destination field 258 indicates the tool bench 106 and its pot number of a transfer destination. A tool field 261 indicates the tool ID of the tool (T05) to be transferred, and a holder field 262 indicates a holder name. Here, it is indicated that the tool (T01) mounted on the holder “HSK-A-100” is carried from the tool bench 106(B01: P03) to the tool bench 106(B22: P10).

After transmission of the transfer instruction information 260, the tool management unit 212 changes the pot 192(P10) of the tool bench 106(B22) from “empty pot” to “reserved pot”, thereby setting that pot to a pot not allowing a tool other than the tool (T01) to be stored therein.

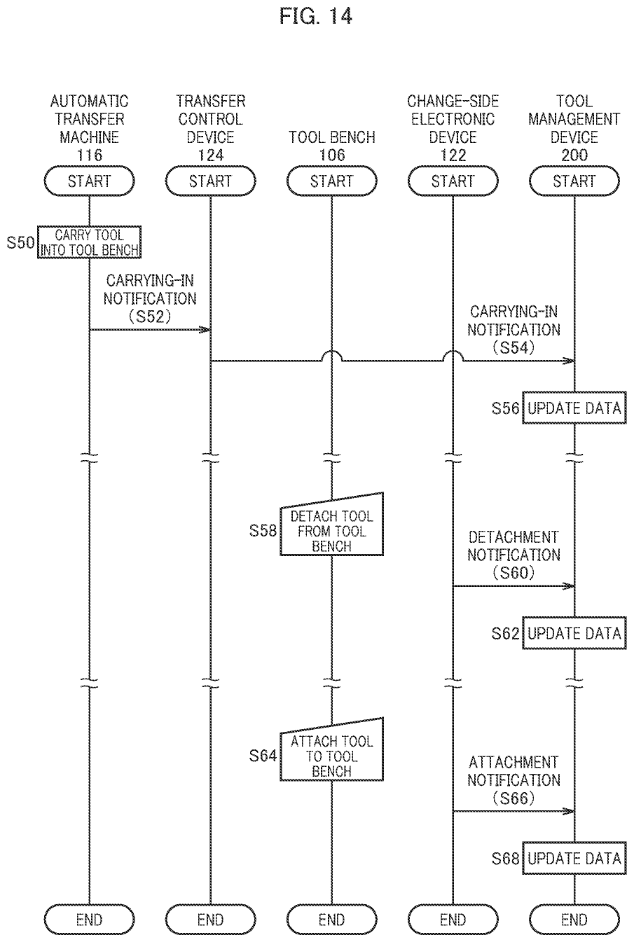

FIG. 14 is a sequence diagram of a processing procedure when the automatic transfer machine 106 carries a tool into the tool bench 106 in the tool-change area 108.

Subsequently, description is made assuming a scene where the tool (T01) stored in the automatic transfer machine 116(A01: P04) is carried into the tool bench 106(B22: P10). The automatic transfer machine 116(A01) moves to near the tool bench 106(B22) as the destination of carrying-in and carries the tool (T01) into the tool bench 106(B22: P10) (S50).

The automatic transfer machine 116(A01) transmits a carrying-in notification indicating that it has carried the tool (T01) into the tool bench 106(B22: P10) to the transfer control device 124 (S52). The transfer control device 124 further forwards the carrying-in notification to the tool management device 200 (S54). The tool management unit 212 updates data in such a manner that the location of the tool (T01) is changed from the automatic transfer machine 116(A02: P04) to the tool bench 106(B22: P10) in accordance with the carrying-in notification (S56).

Next, description is made assuming a scene where the tool (T01) attached to the tool bench 106(B22: P10) is inspected in the tool measurement device 110, is detached from a shank in the tool-change table 112, and is replaced with a new tool (T01).

A changing worker detaches the tool (T01) from the tool bench 106(B22: P10) manually (S58). At this time, the changing worker operates the change-side electronic device 122 corresponding to the tool bench 106(B22) to input detachment. The change-side electronic device 122 transmits a detachment notification to the tool management device 200 (S60). The detachment notification includes the tool-bench ID and a pot number of the tool bench 106(B22) and the tool ID of the detached tool (T01). The tool management unit 212 changes the location of the tool (T01) to “being changed”. The changing worker carries the detached tool (T01) to the tool measurement device 110 and performs inspection and, if necessary, performs tool change on the change table 112.

After inspection and change of the tool (T01), the changing worker attaches the tool (T01) to any of the tool benches 106 in the tool-change area 108 (S64). As for attachment of the tool (T01), the instruction unit 214 instructs in advance the changing worker of the tool bench 106 and the pot 192 (empty pot) to which the tool (T01) is to be attached. It is assumed here that the pot 192(P04) of a tool bench 106(B23) is specified as the carrying-in destination.

After attaching the tool (T01) to the tool bench 106(B23: P04), the changing worker operates the change-side electronic device 122 to input attachment of the tool (T01). The change-side electronic device 122 transmits an attachment notification to the tool management device 200 (S66). After receiving the attachment notification, the tool management unit 212 changes the location of the tool (T01) to the tool bench 106(B23: P04) (S68).

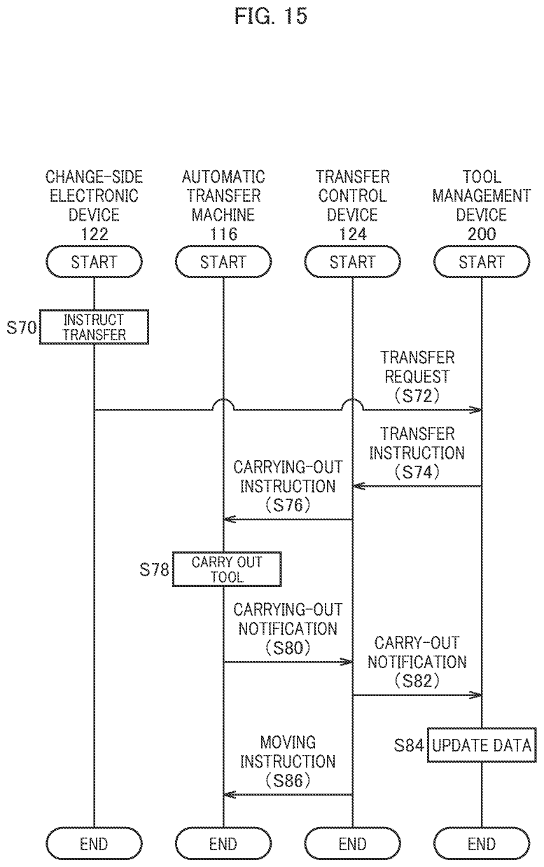

FIG. 15 is a sequence diagram of a processing procedure when the automatic transfer machine 116 transfers a tool to the machining area 102.

Description is made assuming a scene where the tool (T01) stored in the tool bench 106(B23: P04) is carried to the pot 192 (P03) of the tool bench 106(B03). First, a changing worker instructs transfer of the tool (T01) from the tool bench 106(B23: P04) to the tool bench 106(B03) on the change-side electronic device 122 corresponding to the tool bench 106(B23) (S70). The change-side electronic device 122 transmits a transfer request including, for example, the tool ID, the tool-bench ID of the tool bench 106 as a transfer destination, and the tool-bench ID of the tool bench 106 as a transfer source to the tool management device 200 (S72).

The tool management device 200 transmits a transfer instruction for the tool (T01) to the transfer control device 124 (S74). The transfer control device 124 further transmits the transfer instruction to one of the automatic transfer machines 116 which is to transfer the tool (T01) (S76). Here, it is assumed that an automatic transfer machine 116(A03) is selected.

The automatic transfer machine 116(A03) moves to near the tool bench 106(B23) as the transfer source and carries out the specified tool (T01) from the tool bench 106(B23: P04) (S78). The automatic transfer machine 116(A03) picks up the tool (T01) from the tool bench 106(B23) and stores it in an empty pot of the tool storage unit 234, and transmits a carrying-out notification to the transfer control device 124 (S80).

The transfer control device 124 further transmits a carrying-out notification to the tool management device 200 (S82). The tool management unit 212 changes the location of the tool (T01) from the tool bench 106(B23) to the automatic transfer machine 116(A03) (S84). The transfer control device 124 instructs the automatic transfer machines 116(A03) to move to the tool bench 106(B03) (S86).

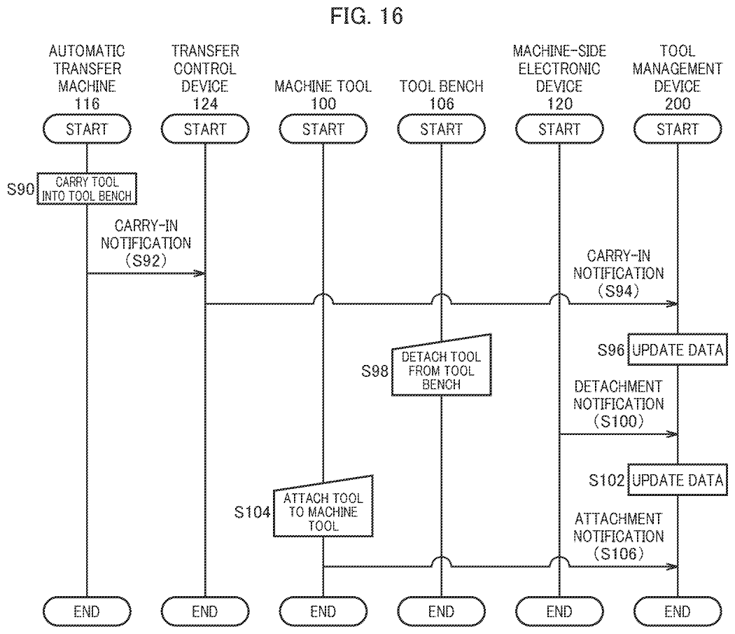

FIG. 16 is a sequence diagram of a processing procedure of carrying a tool into the tool bench 106 in the machining area 102 and then attaching the tool to the machine tool 100.

The automatic transfer machine 116(A03) carries the tool (T01) into a tool bench 106(B03: P03) (S90). The automatic transfer machine 116(A03) transmits a carrying-in notification to the transfer control device 124 (S92). The transfer control device 124 further transmits the carrying-in notification to the tool management device 200 (S94). The tool management device 200 changes the location of the tool (T01) from the automatic transfer machine 116(A03) to the tool bench 106(B03) (S96).

Next, a machining worker detaches the tool (T01) stored in the tool bench 106(B03: P03) therefrom (S98). At this time, the machining worker inputs attachment of the detached tool (T01) to the machine tool 100 on the machine-side electronic device 120 corresponding to the tool bench 106(B03). The machine-side electronic device 120 transmits a detachment notification to the tool management device 200 (S100). The tool management unit 212 changes the location of the tool (T01) from the tool bench 106(B03) to the machine tool 100 (S102).

The machining worker attaches the tool (T01) to the machine tool 100 (S104). After attachment, the machine tool 100 transmits an attachment notification to the tool management device 200 (S106).

### CONCLUSION

The tool management system 118 is described above on the basis of the embodiment.

According to the tool management system 118, the location of a tool can be tracked and managed in an appropriate manner even while the tool is carried between the machining area 102 and the tool-change area 108. A machining worker moves a tool between the machine tool 100 and the tool bench 106. A changing worker moves the tool within the tool-change area 108. The tool is carried between the machining area 102 and the tool-change area 108 by the automatic transfer machine 116. Since work related to carrying of the tool between the machining area 102 and the tool-change area 108 can be automated, work efficiency can be improved.

The present invention is not limited to the embodiment described above and modifications thereof, and any component thereof can be modified and embodied without departing from the scope of the invention. Components described in the embodiments and modifications can be combined as appropriate to form various embodiments. Some components may be omitted from the components presented in the embodiments and modifications.

### MODIFICATION

In the present embodiment, it has been described that the location of the tool bench 106 can be identified by knowing the tool-bench ID thereof because the tool-bench ID is made to correspond to the location number which is in turn made to correspond to the location coordinate. In a modification, the tool-bench ID and the location coordinate may be made to correspond to each other directly. Alternatively, location coordinate data may be used as the tool-bench ID.

When a tool is attached to the tool bench 106, a worker may operate the machine-side electronic device 120, thereby inputting the tool-bench ID of the tool bench 106 and a pot number to which the tool is attached to the machine-side electronic device 120 in addition to the tool ID. The machine-side electronic device 120 may transmit an attachment notification including the tool-bench ID, the pot number, and the tool ID that have been input, to the tool management device 200. The tool management unit 212 may update various types of data related to the tool location based on reception of the attachment notification as a trigger.

This application claims priority to Japanese Patent Application No. 2022-084269 filed on May 24, 2022, which is incorporated herein by reference in its entirety.

What is claimed is:

1. A tool management device comprising:
a data storage unit for storing (i) tool information including a location of a tool and (ii) a tool-bench information including at least a correspondence between a machine tool and a tool bench;
a tool management unit for changing data in the tool information; and
a reception unit for receiving a detachment notification when a tool is detached from the machine tool, wherein
if the detachment notification is received, the tool management unit changes the location of the tool in the tool information from (a) the machine tool to (b) the tool bench corresponding to the machine tool in the tool-bench information.

2. The tool management device according to claim 1, wherein
the tool bench includes a plurality of pots, and
the tool information includes information indicating a tool bench as a storage destination of a tool and one of the pots of the tool bench which is the storage destination of the tool.

3. The tool management device according to claim 1, further comprising an instruction unit for instructing a worker of a tool bench as a storage destination of a tool when the detachment notification is received.

4. The tool management device according to claim 1, wherein, when a tool is picked up from the tool bench by an automatic transfer machine, the tool management unit changes the location of the tool in the tool information from the tool bench to the automatic transfer machine.

5. The tool management device according to claim 4, wherein, when the automatic transfer machine places a tool on a tool bench corresponding to a tool-change area, the tool management unit changes the location of the tool in the tool information from the automatic transfer machine to the tool bench corresponding to the tool-change area.

6. The tool management device according to claim 5, wherein, when the automatic transfer machine picks up a tool from the tool bench corresponding to the tool-change area and carries the tool to a tool bench corresponding to the machine tool, the tool management unit changes the location of the tool in the tool information from the automatic transfer machine to the tool bench corresponding to the machine tool.

7. The tool management device according to claim 6, wherein, when a tool is attached to the machine tool from the tool bench, the tool management unit changes the location of the tool in the tool information from the tool bench corresponding to the machine tool to the machine tool.
